(19) United States
(12) Patent Application Publication
(10) Pub. No.: US 2020/0238305 A1
(43) Pub. Date: Jul. 30, 2020

(54) ON-BOARD SENSOR CLEANING DEVICE

(71) Applicant: DENSO CORPORATION, Kariya-city, Aichi-pref. (JP)

(72) Inventor: Keita SAITO, Kariya-city (JP)

(73) Assignee: DENSO CORPORATION, Kariya-city, Aichi-pref. (JP)

(21) Appl. No.: 16/652,552

(22) PCT Filed: Sep. 27, 2018
(86) PCT No.: PCT/JP2018/035941

§ 371 Date: Mar. 31, 2020

(30) Foreign Application Priority Data
Nov. 28, 2017 (JP) 2017-228134

(51) Int. Cl. B05B 1/14; B05B 13/04; B08B 3/02

(52) U.S. Cl. CPC B05B 1/14; B08B 3/02; B05B 13/04

(57) ABSTRACT

An on-board sensor cleaning device includes a nozzle including one or more ejection ports that eject a fluid onto a sensing surface of an on-board sensor; wherein an ejection duration or an ejection frequency of the fluid, which is ejected onto the sensing surface, differs in accordance with a position on the sensing surface.

### CROSS-REFERENCE TO RELATED APPLICATION

The present application claims priority from Japanese Patent Application No. 2017-228134 filed on Nov. 28, 2017, the entire contents of which are incorporated by reference herein.

### TECHNICAL FIELD

The present disclosure relates to an on-board sensor cleaning device.

### BACKGROUND ART

A known on-board sensor cleaning device ejects a fluid onto the front surface of an optical surface (sensing surface) of an on-vehicle sensor to remove foreign material from the optical surface (for example, refer to Patent Document 1).

The on-board sensor cleaning device ejects a fluid (liquid in Patent Document 1) onto the optical surface while moving a nozzle, which is opposed to the optical surface, along the optical surface.

### PRIOR ART DOCUMENT

### Patent Document

Patent Document 1: European Patent Application Publication No. 3141441

### SUMMARY OF THE INVENTION

The above-described on-board sensor cleaning device is configured to eject a fluid from the nozzle while moving the nozzle back and forth along the optical surface. This allows the fluid to be evenly ejected onto the optical surface. However, since the fluid is evenly ejected onto the entire optical surface, a large amount of the fluid is used for a single action.

It is an object of the present invention to provide an on-board sensor cleaning device that reduces the ejected amount of a fluid.

An on-board sensor cleaning in accordance with one mode of the present disclosure includes a nozzle including one or more ejection ports that eject a fluid onto a sensing surface of an on-board sensor. An ejection duration or an ejection frequency of the fluid, which is ejected onto the sensing surface, differs in accordance with a position on the sensing surface.

In the above mode, the ejection duration or the ejection frequency of the fluid ejected onto the sensing surface differs in accordance with a position on the sensing surface. Therefore, the ejection duration or the ejection frequency of the fluid can be changed, for example, in correspondence with the distance from the nozzle or the level of ejection priority. This reduces the ejected amount of the fluid.

### BRIEF DESCRIPTION OF THE DRAWINGS

FIG. 1 is a perspective view of a sensor system including an on-board sensor cleaning device in accordance with a first embodiment.

FIG. 2 is a perspective view showing the sensor system of FIG. 1 in a state in which a cover is removed.

FIG. 3 is a plan view illustrating a drive unit of the sensor system shown in FIG. 2.

FIG. 4 is a cross-sectional view taken along line 4-4 in FIG. 3.

FIG. 5 is a front view of the sensor system shown in FIG. 1.

FIG. 6 is a diagram illustrating a control example of a nozzle of the on-board sensor cleaning device shown in FIG. 1.

FIG. 7 is a perspective view of an on-board sensor cleaning device in accordance with a second embodiment.

FIG. 8 is a front view of a sensor system including the on-board sensor cleaning device shown in FIG. 7.

FIG. 9 is a plan view illustrating the on-board sensor cleaning device of FIG. 7.

FIG. 10 is a diagram illustrating a control example of a nozzle of the on-board sensor cleaning device shown in FIG. 7.

FIG. 11 is a front view of a sensor system in accordance with a third embodiment.

FIG. 12 is a time diagram illustrating an ejection time of ejection ports of an on-board sensor cleaning device shown in FIG. 11.

FIG. 13 is a front view showing a sensor system of a modified example.

FIG. 14 is a diagram illustrating ejection ports of a nozzle of the modified example shown in FIG. 13.

FIG. 15 is a front view showing a sensor system of a modified example.

FIG. 16 is a front view showing a sensor system of a modified example.

FIG. 17 is a front view showing a sensor system of a modified example.

FIG. 18 is a time diagram illustrating an ejection time of ejection ports of an on-board sensor cleaning device of the modified example.

FIG. 19 is a front view showing a sensor system of a modified example.

FIG. 20 is a diagram illustrating a rotation speed of a nozzle of the sensor system shown in FIG. 19.

FIG. 21 is a front view showing a sensor system of a modified example.

FIG. 22 is a cross-sectional view showing part of an electric pump device in the sensor system of FIG. 21.

FIG. 23 is an exploded perspective view of a passage switching unit shown in FIG. 22.

FIG. 24 is a perspective cross-sectional view showing part of the passage switching unit of FIG. 22.

FIG. 25 is a perspective cross-sectional view showing part of the passage switching unit of FIG. 22.

FIG. 26 is a perspective cross-sectional view showing part of the passage switching unit of FIG. 22.

FIG. 27 is a perspective cross-sectional view showing part of the passage switching unit of FIG. 22.

FIG. 28 is a perspective cross-sectional view showing part of the passage switching unit of FIG. 22.

FIG. 29 is a perspective cross-sectional view showing part of the passage switching unit of FIG. 22.

FIG. 30 is a plan view of the passage switching unit shown of FIG. 22.

FIG. 31 is a schematic diagram showing an on-board sensor cleaning device of a modified example.

FIG. 32 is a plan view of the passage switching unit shown in FIG. 31.

### MODES FOR CARRYING OUT THE INVENTION

### First Embodiment

A first embodiment of a sensor system including an on-board sensor cleaning device will now be described.

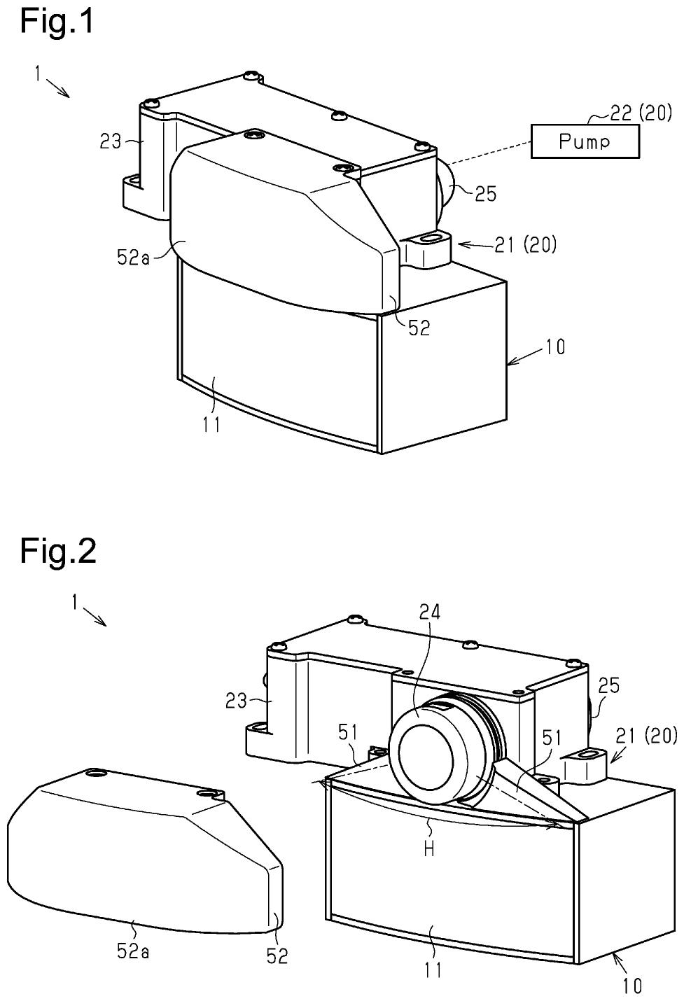

As shown in FIG. 1, a sensor system 1 of the present embodiment includes an on-board optical sensor 10 and an on-board sensor cleaning device 20. The on-board optical sensor 10 serves as an on-board sensor. The on-board sensor cleaning device 20 is arranged on the on-board optical sensor 10 to clean an optical surface 11 of the on-board optical sensor 10.

The on-board optical sensor 10 (e.g. LIDAR) is configured to radiate (emit), for example, an infrared laser beam and receive scattered light reflected by an object so as to measure the distance to the object. The on-board optical sensor 10 includes the optical surface 11 serving as a sensing surface that allows for transmission of a laser beam. In the following description, the side toward which the optical surface 11 is faced will be referred to as the front, and the opposite side will be referred to as the rear. Further, unless particularly indicated, the direction in which the on-board sensor cleaning device 20 is arranged on the on-board will be referred to as the top-bottom direction or vertical direction, and the direction orthogonal to the top-bottom direction and a front-rear direction will be referred to as the sideward direction.

The optical surface 11 is bulged toward the front and curved as viewed in the top-bottom direction.

As shown in FIG. 1, the on-board sensor cleaning device 20 includes a nozzle unit 21 and a pump 22. The nozzle unit 21 is arranged on (upper side in vertical direction) the on-board optical sensor 10. The pump 22 supplies air (gas) serving as a fluid to the nozzle unit 21.

As shown in FIGS. 1 to 4, the nozzle unit 21 includes a case 23, a nozzle 24, a connecting portion 25, and a drive unit 26. The nozzle 24 is a movable nozzle arranged in a manner at least partially exposed toward the front from the case 23. The connecting portion 25 is located between the nozzle 24 and the pump 22. The case 23 accommodates the drive unit 26.

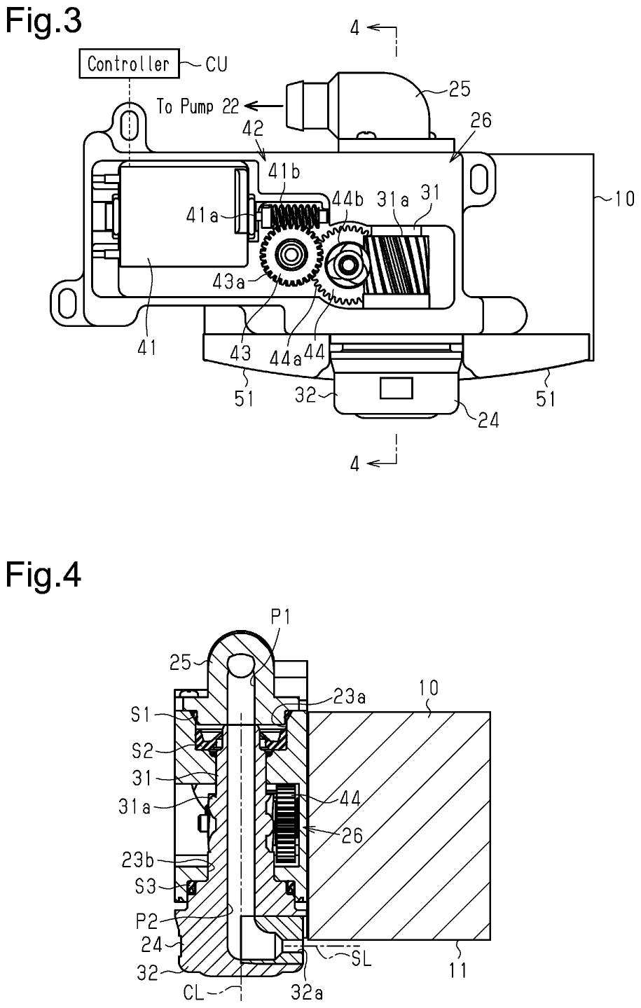

As shown in FIGS. 3 and 4, the connecting portion 25 is fixed by screws in a state in which the connecting portion 25 is partially inserted into a socket 23a in a rear portion of the case 23. The connecting portion 25 is connected to the pump 22 by, for example, a hose (not shown) and configured to draw the air supplied from the pump 22 into passage P1 that is defined in the connecting portion 25. The passage P1 in the connecting portion 25 is configured to be bent in the connecting portion 25 and substantially L-shaped.

As shown in FIG. 4, an annular seal member S1 is arranged between the socket 23a and the connecting portion 25. This prevents water or the like from entering the socket 23a.

As shown in FIGS. 3 and 4, the nozzle 24 includes a cylindrical portion 31 and a main body 32. The cylindrical portion 31 extends in the front-rear direction. The main body 32, which is located in front of the cylindrical portion 31, is disk-shaped (cylindrical) and has a larger diameter than the cylindrical portion 31. The cylindrical portion 31 of the nozzle 24 is located in front of the connecting portion 25 and pivotally supported in a state inserted through the socket 23a and a socket 23b. The sockets 23a and 23b are respectively arranged at the front and the rear of the case 23. The main body 32 is formed integrally with the cylindrical portion 31. The main body 32 includes one ejection port 32a configured to eject the air (gas) supplied from the pump 22. In the present example, an ejection axis SL is set to substantially extend through the center of the single ejection port 32a.

The nozzle 24 is entirely located above the on-board optical sensor 10 (optical surface 11) so that the nozzle 24 does not oppose the optical surface 11.

Further, the nozzle 24 includes passage P2 extending through the cylindrical portion 31 and the main body 32. The rear of the cylindrical portion 31 is located opposing the front of the connecting portion 25 so that the passage P1 in the connecting portion 25 is connected to the passage P2 in the nozzle 24. Thus, the air (gas) supplied from the pump 22 passes through the passage P1 in the connecting portion 25 and the passage P2 in the nozzle 24 and is ejected from the ejection port 32a of the main body 32 in the nozzle 24. Here, the passage P2 in the nozzle 24 is configured to be bent in the main body 32 and substantially L-shaped so that the ejection port 32a is directed downward in the vertical direction.

An annular seal member S2 is arranged at the rear end of the cylindrical portion 31, to seal a gap between the cylindrical portion 31 and the socket 23a. A seal member S3 is arranged at the front side of the cylindrical portion 31 to seal a gap between the cylindrical portion 31 and the socket 23b. This prevents water or the like from entering the gaps between the cylindrical portion 31 and each of the sockets 23a and 23b.

As shown in FIG. 3, the drive unit 26 serving as a pivot mechanism includes a motor 41 and a reduction gear mechanism 42 in the case 23. The drive unit 26 pivots (swings) the nozzle 24 exposed from the case 23 with a rotational driving force of the motor 41.

As shown in FIG. 3, the reduction gear mechanism 42 includes a worm 41b, a first gear 43, a second gear 44, and a worm wheel 31a. The motor 41 includes an output shaft 41a, and the first gear 43 includes a worm wheel 43a. The worm 41b is formed on the output shaft 41a and mates with the worm wheel 43a. The worm 41b (output shaft 41a of motor 41) extends in the sideward direction, which corresponds to a widthwise direction of the on-board optical sensor 10. This minimizes the size of the on-board sensor cleaning device 20 in the front-rear direction, which corresponds to a direction in which a sensing axis of the on-board optical sensor 10 extends (detection direction).

The first gear 43, which engages with the worm 41b, includes the worm wheel 43a and a spur gear (not shown) that is formed integrally with the worm wheel 43a and rotated coaxially with the worm wheel 43a. The spur gear (not shown) is engaged with a spur gear 44a of the second gear 44. The second gear 44 includes the spur gear 44a and a worm 44b that is configured integrally with the spur gear 44a and rotated coaxially with the spur gear 44a. The worm 44b mates with the worm wheel 31a formed on an outer circumferential surface of the cylindrical portion 31 of the nozzle 24. Thus, the reduction gear mechanism 42 transmits the rotational driving force of the motor 41 to the cylindrical portion 31 of the nozzle 24 so that the rotation speed is low and the torque is high. This pivots the cylindrical portion 31 and the main body 32, which is integrated with the cylindrical portion 31, and changes the direction in which the ejection port 32a is directed. In this case, the nozzle 24 is pivoted back and forth at a substantially constant speed in a predetermined range H on the optical surface 11 (refer to FIG. 2). That is, the motor 41 is switched between forward rotation and reverse rotation. Further, the nozzle 24 is pivoted about a center axis CL of the cylindrical portion 31. The center axis CL of the cylindrical portion 31 coincides with the center axis of the passage P2 in the cylindrical portion 31. That is, the passage P2 is set on the center axis CL, which is the pivot center of the cylindrical portion 31.

Moreover, guide walls are arranged in a pivot direction of the nozzle 24 at two sideward ends of the nozzle 24. The guide walls 51 are continuous with the optical surface 11. Each guide wall 51 includes a curved front surface having substantially the same curvature as the optical surface 11. The guide wall 51 is configured to be narrowed as it becomes farther from the nozzle 24, and the front surface of the guide wall 51 is substantially triangular. The guide wall 51 is configured so that a lower end is parallel to the upper edge of the optical surface 11 and located at substantially the same position as the nozzle 24 in the vertical direction. Further, in the vicinity of the nozzle 24, the guide walls 51 have a height in the vertical direction that is substantially equivalent to the radius of the main body 32 of the nozzle 24.

A nozzle cover 52 is provided in front of the nozzle 24 to cover the nozzle 24 and limit exposure of the nozzle 24 to the outside. The nozzle cover 52 is attached to the case 23 by screws. The nozzle cover 52 may be attached through other means such as snap-fitting. The nozzle cover 52 is configured so that, for example, a front cover portion 52a that covers the nozzle 24 is curved at substantially the same curvature as the optical surface 11. Accordingly, the distance between the front cover portion 52a and the optical surface 11 in a direction orthogonal to the optical surface 11 is substantially constant over the entire front cover portion 52a and the optical surface 11 in a circumferential direction (curvature direction).

The on-board sensor cleaning device 20 of the present embodiment includes a controller CU that controls and drives the motor 41. The controller CU controls a rotation speed of the motor 41 to change an ejection duration of a fluid ejected onto the optical surface 11 in accordance with a position on the optical surface 11.

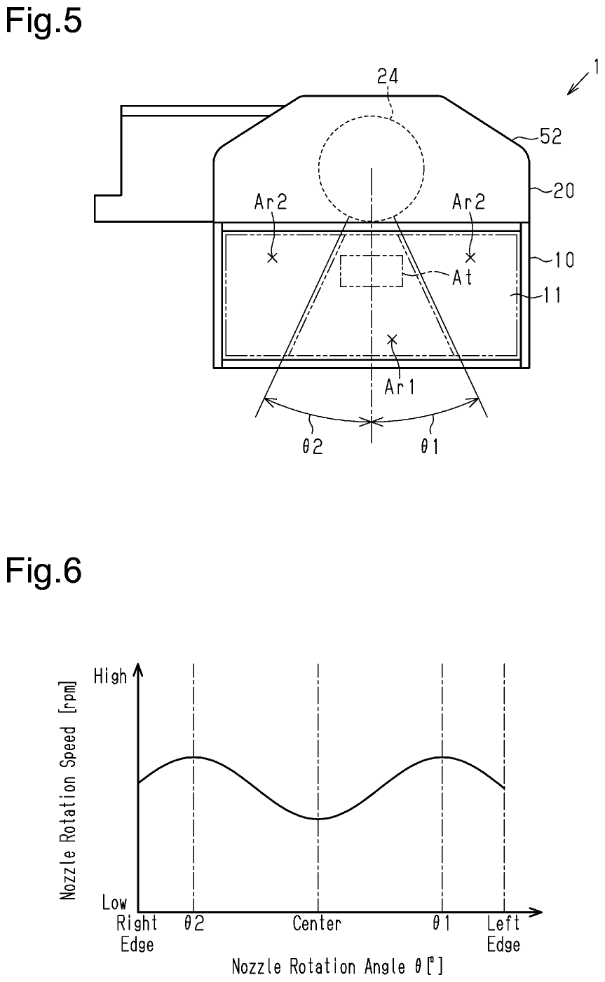

As shown in FIG. 5, in the present example, an important region Ar1 and a regular region Ar2 are set in advance. The important region Ar1 has a relatively high ejection priority, and the regular region Ar2 has a relatively lower ejection priority than the important region Ar1. The important region Ar1 is located at a central portion of the optical surface 11 including a transmission range At, through which light (e.g., infrared laser light) that is emitted from a light emitter (not shown) accommodated in the on-board optical sensor 10 is transmitted (passes through). In the present example, the important region Ar 1 is a region that is substantially trapezoidal. The regular region Ar2 is located at each of two sideward ends of the optical surface 11 in the sideward direction and excludes the important region Ar1. In the present example, each regular region A2 is a region that is substantially trapezoidal.

As shown in FIGS. 3, 5, and 6, when the ejection axis SL is located in the important region Ar1, the controller CU controls the rotation speed of the motor 41 (rotation speed of nozzle 24) to be lower than a maximum rotation speed of the motor 41 (maximum rotation speed of nozzle 24) when the ejection axis SL is located in the regular region Ar2. In the present example, the motor 41 is rotated at a minimum rotation speed (minimum rotation speed of nozzle 24) when the ejection axis SL extends into the important region in the downward vertical direction. The motor 41 is rotated at the maximum rotation speed (maximum rotation speed of nozzle 24) when the ejection axis SL extends into the regular region Ar2 in the downward vertical direction at a position, which is deviated in the sideward direction by predetermined angle θ1 or θ2 from the central position of the optical surface 11 in the sideward direction. The position of the ejection axis SL can be estimated from, for example, a rotation position of the motor 41.

The controller CU controls the motor 41 as described above to set the ejection duration of fluid per unit area is set to be longer in the important region Ar1 than in the regular region Ar2.

The operation of the on-board sensor cleaning device 20 will now be described.

The nozzle unit 21 of the on-board sensor cleaning device 20 in the present embodiment is located at the upper side of the on-board optical sensor 10 in the vertical direction. When the pump 22 is driven, the air supplied from the pump 22 passes through the passages P1 and P2 and is continuously ejected from the ejection port 32a of the nozzle 24.

Further, the on-board sensor cleaning device 20 of the present embodiment is configured so that when the motor 41 is rotated and driven, rotational driving force, which is transmitted by the reduction gear mechanism 42 to the nozzle 24, pivots the nozzle 24. The forward and rearward rotation of the motor 41 pivots the ejection axis SL of the nozzle 24 back and forth on the optical surface 11.

In the on-board sensor cleaning device 20 of the present embodiment, the nozzle 24 is separated (toward upper side in vertical direction) from a position opposing the optical surface 11. Thus, the nozzle 24 will not be located on the optical surface 11 even when the nozzle 24 is pivoted to change the position of the ejection axis SL. This limits adverse effects on the sensing performance of the on-board sensor cleaning device 20.

Further, in the on-board sensor cleaning device 20 of the present embodiment, the controller CU controls the rotation speed of the motor 41 at which the nozzle 24 is pivoted. The controller CU controls the rotation speed of the motor 41 (rotation speed of nozzle 24) so that the maximum rotation speed of the motor 41 (maximum rotation speed of nozzle 24) is lower when the ejection axis SL is located in the important region Ar1 than when the ejection axis SL is located in the regular region Ar2. Thus, the rotation speed of the motor 41 (rotation speed of nozzle 24) is set to be relatively low in the important region Ar1 so as to increase a supply amount of the fluid per unit area in the important region Ar1. This reduces unnecessary ejection of the fluid.

The advantages of the present embodiment will now be described.

(1) The ejection duration of the fluid ejected onto the optical surface 11 is varied in accordance with a position on the optical surface 11 so that the ejection duration of the fluid can be changed in correspondence with, for example, the ejection priority on the optical surface 11. This reduces the ejected amount of the fluid.

(2) The ejection duration of fluid per unit area in the important region Ar1 where the ejection priority is high is set to be longer than that in the regular region Ar2 so that a greater amount of fluid is ejected to a portion that is more essential (important) than other portions. This reduces unnecessary ejection of the fluid.

(3) The important region Ar1 is set at the central portion of the optical surface 11 so that a greater amount of fluid is ejected to the central portion of the optical surface 11 than the non-central portions of the optical surface 11.

(4) The important region Ar1 includes the transmission range At through which light emitted from a light emitter of the on-board optical sensor 10 is transmitted through in the optical surface 11. This will reduce an amount of foreign material on the optical surface 11 that obstructs light emitted from the light emitter.

(5) The ejected amount of fluid can be reduced even when the employed nozzle 24 moves the ejection port 32a to change the ejection axis SL of the ejection port 32a.

(6) The ejected amount of fluid can be reduced in a structure in which the fluid is a gas.

### Second Embodiment

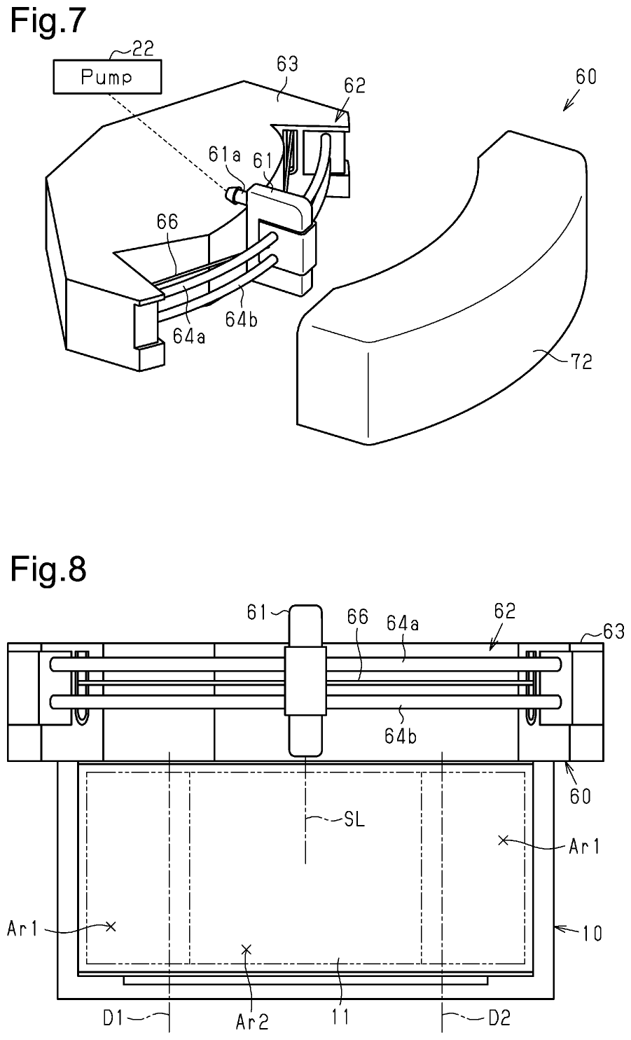

An on-board sensor cleaning device of a second embodiment will now be described with related with FIGS. 7 to 10.

As shown in FIGS. 7 to 9, an on-board sensor cleaning device 60 of the present embodiment includes a slide mechanism 62 that is configured to slide a nozzle 61.

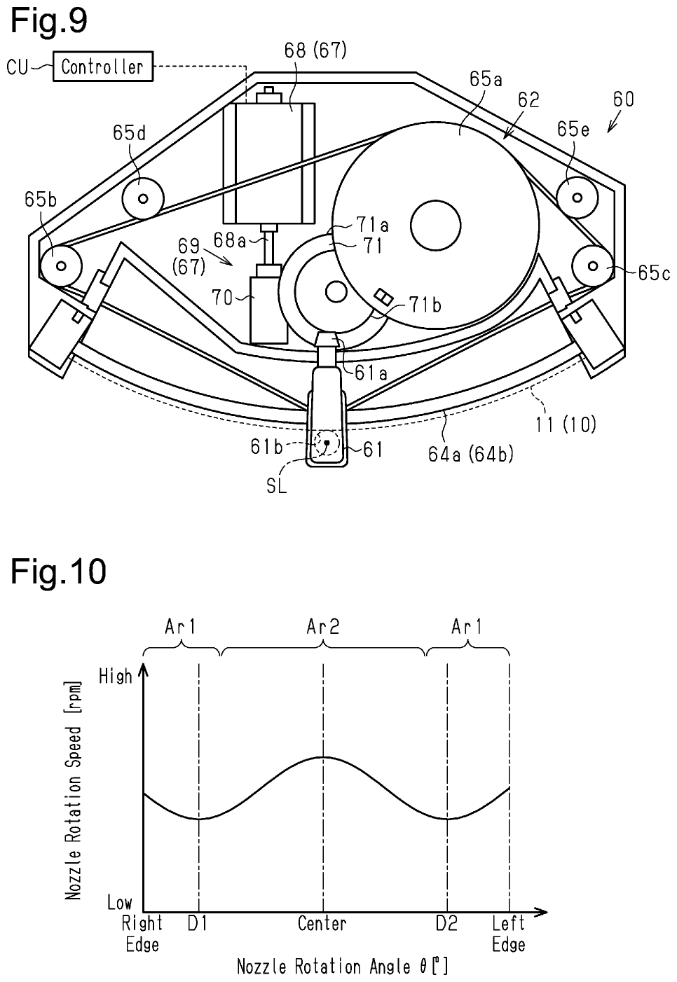

As shown in FIGS. 7 and 9, the nozzle 61 includes a connecting portion 61a that has a rear part configured to be connected to the pump 22. The pump 22 is connected to the connecting portion 61a through a hole (not shown). Further, the nozzle 61 includes a passage through which a fluid (air) supplied from the pump 22 passes for ejection from one ejection port 61b.

As shown in FIGS. 7 to 9, the slide mechanism 62 includes two guide rails 64a and 64b, pulleys 65a to 65e, a wire 66, and a drive unit 67. The guide rails 64a and 64b are supported by a case 63. The wire 66 runs around the pulleys 65a to 65e. The drive unit 67 moves the wire 66 that rotates and drives the pulleys 65a to 65e.

The guide rails 64a and 64b are arranged along the optical surface 11 of the on-board optical sensor 10. The guide rails 64a and 64b are spaced part from each other in a top-bottom direction, and two sideward ends of the guide rails 64a and 64b are supported by the case 63.

The drive unit 67 includes a motor 68 and a reduction gear mechanism 69. The reduction gear 69 includes a worm 70 and a first gear 71. The motor 68 includes an output shaft 68a on which the worm 70 is arranged. The first gear 71 includes a worm wheel 71a engaged with the worm 70. The first gear 71 includes a small diameter gear 71b that rotates coaxially with the worm wheel 71a. The small diameter gear 71b mates with a gear (not shown) that rotates coaxially with a drum pulley 65a. Thus, when the output shaft 68a of the motor 68 is driven and rotated, rotational driving force is transmitted to the drum pulley 65a thereby rotating the drum pulley 65a.

The pulleys 65a to 65e include the drum pulley 65a, guide pulleys 65b and 65c, and two tension pulleys 65d and 65e. The drum pulley 65a is configured to draw and send out the wire 66 when rotated. The guide pulleys 65b and 65c are respectively located at opposite sides of the drum pulley 65a in the sideward direction. The tension pulleys 65d and 65e are respectively located between the drum pulley 65a and the guide pulley 65b and between the drum pulley 65a and the guide pulley 65c to apply appropriate tension to the wire 66 so that the wire 66 to limit slack.

The wire 66 is configured to be connected to the nozzle 61. Thus, for example, when the drum pulley 65a is rotated, the wire 66 is drawn by the drum pulley 65a from one end in the sideward direction and sent out from the other end in the sideward direction to move the wire 66 in the sideward direction. This slides the nozzle 61 along the guide rails 64a and 64b. Further, the wire 66 is located between the guide rails 64a and 64b in the vertical direction. This moves the wire 66 and stably moves the nozzle 61 along the guide rails 64a and 64b.

As shown in FIG. 7, a nozzle cover 72 is arranged in front of the nozzle 61 to cover the nozzle 61 and limit exposure to the outside. The nozzle cover 72 does not interfere with the nozzle 61 in a range in which the nozzle 61 moves. The arrangement of the nozzle cover 72 prevents flying objects or the like from directly striking the nozzle 61 in the movement range.

Further, the on-board sensor cleaning device 60 slides the nozzle 61 along the guide rails 64a and 64b of the slide mechanism 62 and drives the pump 22 to eject fluid (air) from the ejection port 61b of the nozzle 61. This allows fluid to be ejected over a wide range of the optical surface 11.

In the present example, the important region Ar1 having a high ejection priority is set in advance at each of the two sideward ends of the optical surface 11, and the regular region Ar2 having a low ejection priority is set in advance at a central portion of the optical surface 11. Further, in the present example, the important region Ar1 and the regular region Ar2 are rectangular.

As shown in FIGS. 8 to 10, when the ejection axis SL is located in the important region Ar1, the controller CU controls the rotation speed of the motor 68 (rotation speed of nozzle 61) to be lower than the maximum rotation speed of the motor 68 (maximum rotation speed of nozzle 61) when the ejection axis SL is located in the regular region Ar2. In the present example, the motor 68 rotates at the maximum rotation speed (maximum rotation speed of nozzle 61) when the ejection axis SL extends into the important region Ar1 in the downward vertical direction. The motor 68 rotates at the minimum rotation speed (minimum rotation speed of nozzle 61) when the ejection axis SL extends into the important region Ar1 in the downward vertical direction at predetermined positions D1 or D2, which is deviated in the sideward direction from the central position of the optical surface 11 in the sideward direction.

The controller CU controls the motor 68 as described above to set the ejection duration of fluid per unit area to be longer in the important region Ar1 than the regular region Ar2.

The on-board sensor cleaning device 60 has advantages (1), (2), and (6) of the first embodiment.

### Third Embodiment

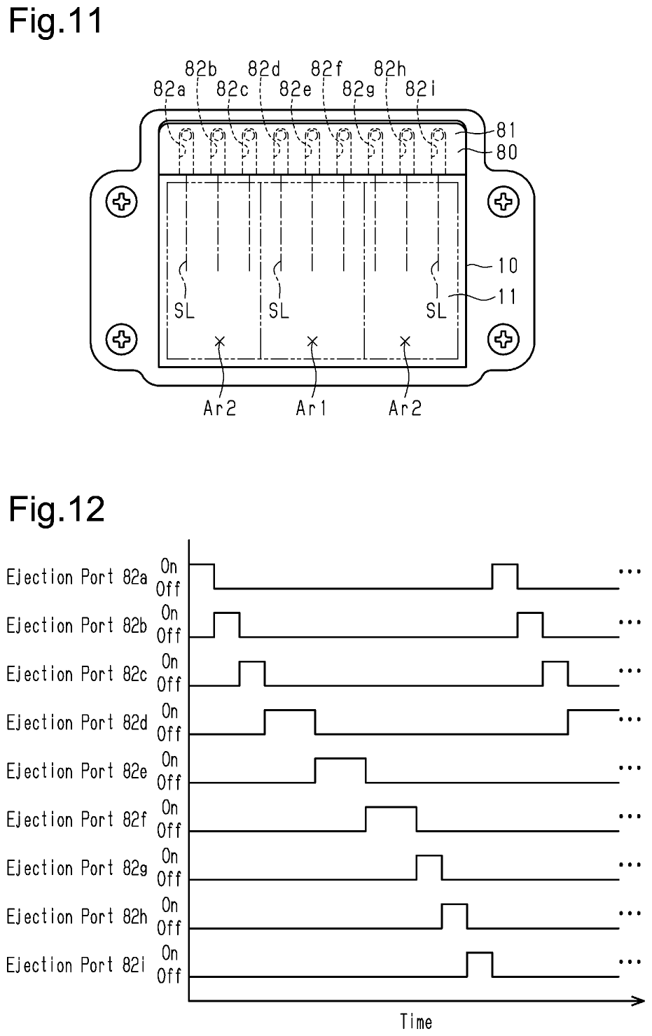

An on-board sensor cleaning device of a third embodiment will now be described with reference to FIGS. 11 and 12.

As shown in FIG. 11, an on-board sensor cleaning device 80 of the present embodiment includes a fixed nozzle 81 in which a nozzle is fixed. The fixed nozzle 81 includes a plurality of (nine in the present example) ejection ports 82a, 82b, 82c, 82d, 82e, 82f, 82g, 82h, and 82i. Thus, the present embodiment differs from the first and second embodiments in that the nozzle is not pivoted or moved.

The ejection ports 82a to 82i are arranged in substantially equal intervals in a sideward direction. The ejection ports 82a to 82i are configured to eject the same amount of the air in each ejection.

In the present example, the important region Ar1 having a relatively high ejection priority is set in advance at a central portion of the optical surface 11 in the sideward direction, and the regular region Ar2 having a relatively low ejection priority is set in advance at each of the two sideward ends of the optical surface 11. In other words, the regular region Ar2 is set at each of left and right sides of the important region Ar1. Further, in the present example, the important region Ar1 and the regular region Ar2 are rectangular.

The important region Ar1 has substantially the same area as the regular region Ar2. That is, the area of the important region Ar1 is substantially one-half of the sum of the areas of each regular region Ar2.

The ejection axes SL of the three ejection ports 82a, 82b, and 82c are set in one regular region Ar2. The ejection axes SL of the three ejection ports 82g, 82h, and 82i are set in the other regular region Ar2. The ejection axes SL of the three ejection ports 82d, 82e, and 82f are set in the important region Ar1.

The controller CU controls, for example, a passage switching means (for example, valve) to control the ejection time at which the ejection ports 82a to 82i eject air. In the present example, the controller CU controls the passage switching means so that, for example, the ejection ports 82a to 82i sequentially perform ejection.

As shown in FIG. 12, the ejection time of the ejection ports 82a to 82i is switched in a single cycle in the order of the ejection port 82a, ejection port 82b, ejection port 82c, ejection port 82d, ejection port 82e, ejection port 82f, ejection port 82g, ejection port 82h, and ejection port 82i. In a single cycle, the ejection duration (ON duration) of the ejection ports 82d, 82e, and 82f, of which the ejection axes SL are set in the important region Ar1 where the ejection priority is relatively high, is longer than the ejection duration (ON duration) of the ejection ports 82a, 82b, 82c, 82g, 82h, and 82i, of which the ejection axes SL are set in the regular regions Ar2 where the ejection priority is relatively low. This allows the ejection duration of fluid per unit area in the important region Ar1 to be longer than that in the regular region Ar2. The order of ejection from the ejection ports 82a to 82i in a single cycle may be changed as long as each of the ejection ports 82a to 82i performs an ejection once.

The on-board sensor cleaning device 80 has following advantage in addition to advantages (1) to (4) and (6) of the first embodiment.

(7) Among the ejection ports 82a to 82i of the fixed nozzle 81, the ejection ports 82d, 82e, and 82f, which have the ejection axes SL set in the important region Ar1, have prolonged fluid ejection durations. This allows the fixed nozzle 81 to eject a greater amount of fluid onto the important region Ar1 than the regular regions Ar2. This reduces unnecessary ejection of fluid.

The above embodiments may be modified as described below.

In the first and second embodiments, the nozzle 24 and 61 respectively include the ejection ports 32a and 61b. However, there is no limitation to such a structure.

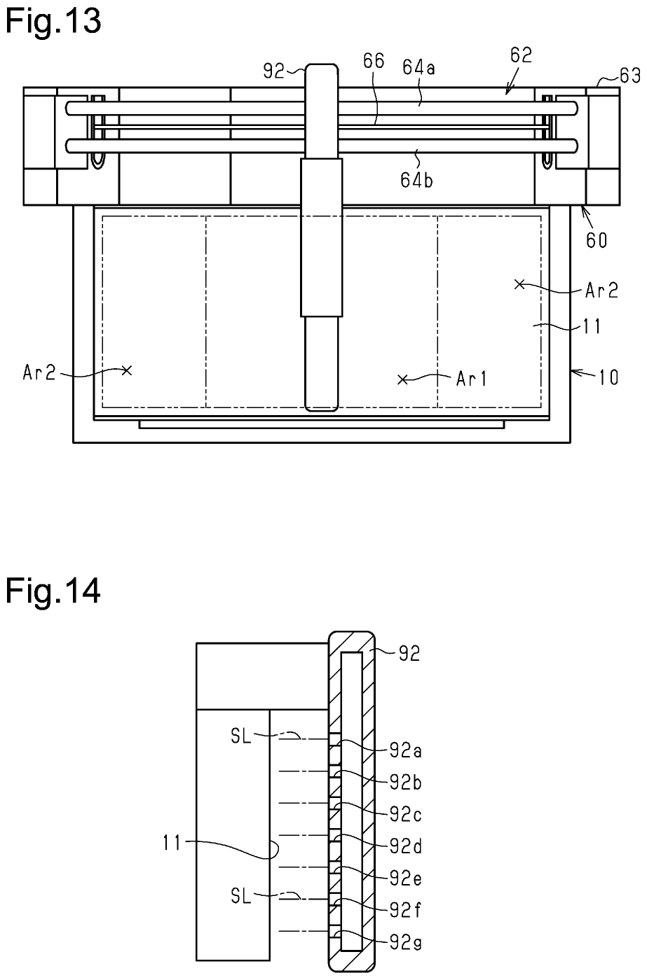

As shown in FIGS. 13 and 14, the nozzle 92 may include a plurality of ejection ports 92a, 92b, 92c, 92d, 92e, and 92f. The structure illustrated in FIGS. 13 and 14 uses the slide mechanism 62 of the second embodiment. However, the positional relationship of the important region Ar1 and the regular regions Ar2 differs from the second embodiment.

The first embodiment includes one nozzle 24 as a movable nozzle. However, there is no limitation to such a structure.

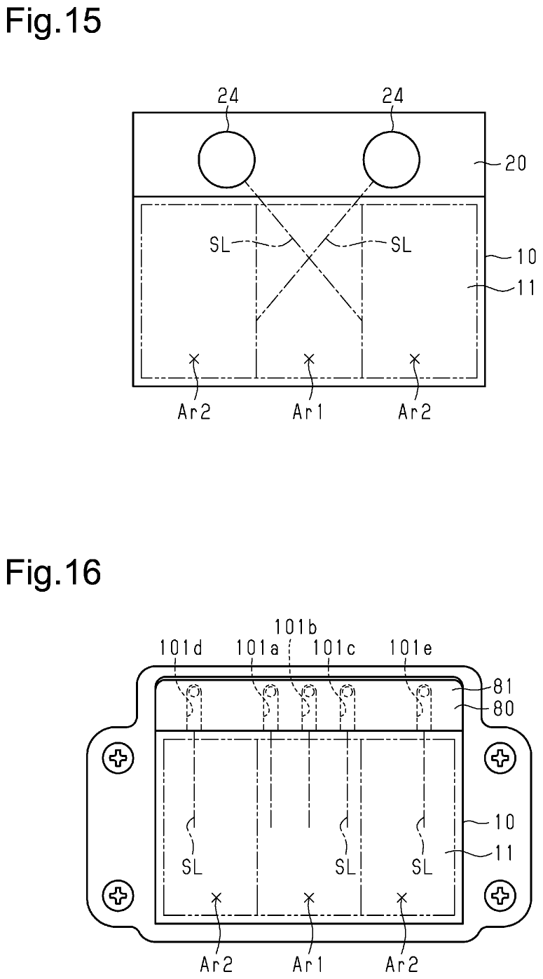

As shown in FIG. 15, a plurality (two in FIG. 15) of nozzles 24, which are movable (pivotal), may be arranged. Preferably, the ejection axis SL of each of the movable nozzles 24 is configured to be set in the important region Ar1. Such a structure allows fluid from each nozzle 24 to be ejected onto the important region Ar1. In the example shown in FIG. 15, the important region Ar1 and the regular regions Ar2 are rectangular, which differs from the first embodiment.

In the third embodiment, nine ejection ports 82a to 82i are arranged in the single nozzle 81. However, there is no limitation to such a structure, and changes can be made to the structure.

In the third embodiment, the area of the important region Ar1 is set to have substantially the same area as the regular region Ar2 located at each of left and right sides of the important region Ar1 in the sideward direction, and the three regions each have the same number of ejection axes SL of the ejection ports 82a to 82i. However, there is no limitation to such a structure.

As shown in FIG. 16, the number of ejection ports 101a to 101c, of which the ejection axes SL are set in the important region Ar1, may be greater than the number of ejection ports 101d and 101e, of which the ejection axes SL are set in the regular regions Ar2. In the structure illustrated in FIG. 16, the ejection axes SL of the three ejection ports 101a to 101c are set in the important region Ar1, and the ejection axes SL of the ejection ports 101d and 101e are respectively set in the left and right regular regions Ar2. The number of the ejection ports of which the ejection axes SL are set in the important region Ar1 is greater than the number of ejection ports of which the ejection axis SL is set in the regular region Ar2. This allows a greater amount of fluid to be ejected onto the important region Ar1 than the regular regions Ar2. Thus, unnecessary ejection of fluid is reduced.

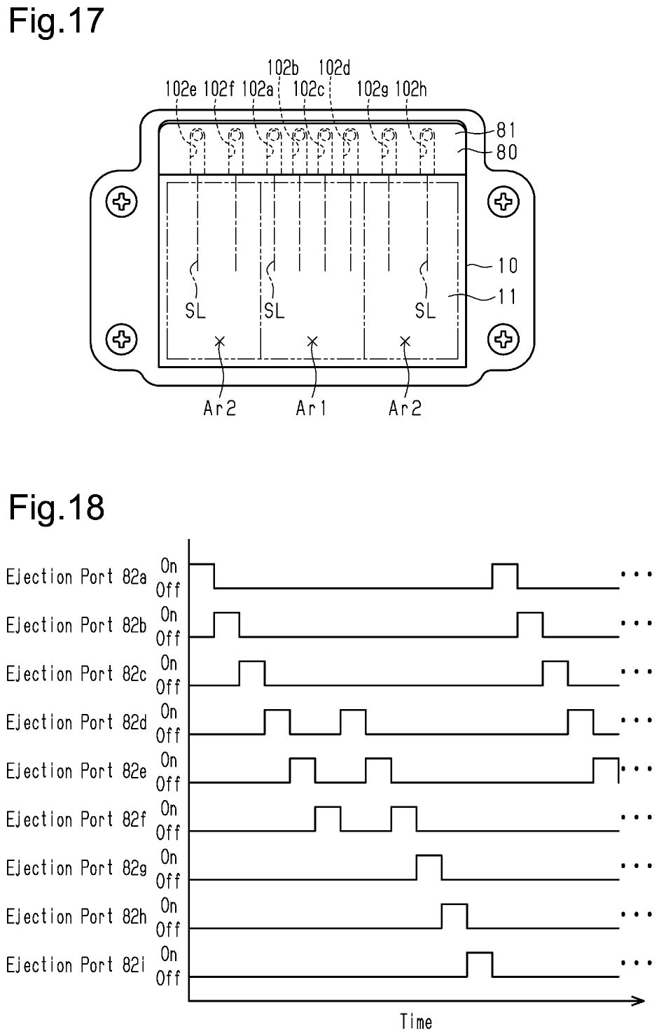

As shown in FIG. 17, a plurality of ejection ports 102a to 102d, of which the ejection axes SL are set in the important region Ar1, and a plurality of ejection ports 102e to 102h, of which the ejection axes SL are set in the regular region Ar2, are provided. In this case, arrangement intervals in which the ejection ports 102a to 102d, of which the ejection axes SL are set in the important region Ar1, are arranged may be narrower than arrangement intervals in which the ejection ports 102e to 102h, of which the ejection axes SL are set in the regular region Ar2, are arranged. Such a structure allows a larger amount of fluid to be ejected onto the important region Ar1 than onto the regular regions Ar2. This reduces unnecessary ejection of the fluid.

In the third embodiment, the ejection ports 82a to 82i sequentially eject fluid one at a time, but more than two ejection ports can simultaneously eject fluid.

In the above embodiments, the ejected amount of fluid per unit area is varied by changing the ejection duration of the fluid. However, there is no limitation to such a configuration. The ejected amount of fluid per unit area may be varied by changing an ejection frequency. An example in which the ejection frequency is changed in the third embodiment will now be described.

As shown in FIG. 18, the ejection time of the ejection ports 82a to 82i in a single cycle is switched in the order of the ejection port 82a, ejection port 82b, ejection port 82c, ejection port 82d, ejection port 82e, ejection port 82f, ejection port 82d, ejection port 82e, ejection port 82f, ejection port 82g, ejection port 82h, and ejection port 82i. That is, in a single cycle, the ejection frequency of the ejection ports 82d, 82e, and 82f, of which the ejection axes SL are set in the important region Ar1 where the ejection priority is relatively high, is higher than the ejection frequency of the ejection ports 82a, 82b, 82c, 82g, 82h, and 82i, of which the ejection axes SL are set in the regular regions Ar2 where the ejection priority is relatively low. This allows for the ejected amount of fluid per unit area in the important region Ar1 to be greater than that in the regular region Ar2.

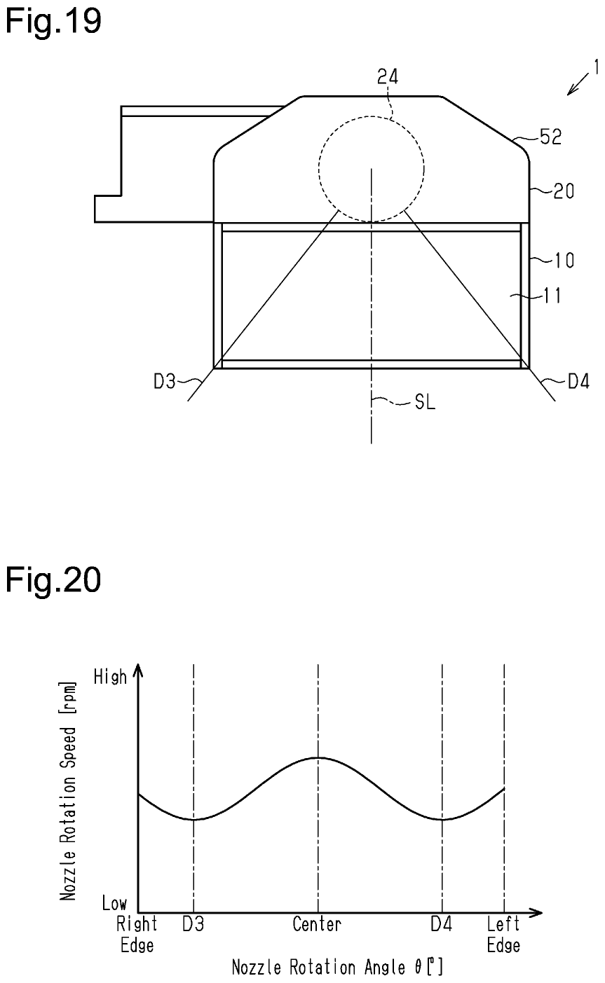

In the above embodiments, the ejected amount of fluid per unit area differs between the important region Ar1 and the regular region Ar2. That is, the ejected amount of fluid per unit area is varied in accordance with the ejection priority. However, there is no limitation to such a configuration. The ejection duration or the ejection frequency may be varied based on the distance to the optical surface 11 relative to the direction in which the ejection axis SL extends. One such example will now be described with reference to FIGS. 19 and 20.

As shown in FIGS. 19 and 20, position D3, located between the center and the left edge of the swing range of the nozzle 24 (predetermined range H in FIG. 2), and position D4, located between the center and the right edge of the swing range (predetermined range H in FIG. 2), are the farthest from the nozzle 24 on the optical surface 11 (positions corresponding to left and right edges of lower edge of the optical surface 11). The motor 41 is controlled to decrease the rotation speed of the nozzle 24 as the distance to the optical surface 11 increases in the direction in which the ejection axis SL extends. This increases the ejection duration of fluid onto the portions far from the nozzle 24, where the fluid cannot easily reach.

In the above embodiments, the optical surface 11 serving as a sensing surface is curved. However, there is no limitation to such a structure. The optical surface 11 may be, for example, flat.

In the above embodiments, the on-board sensor cleaning devices 20, 60, and 80 are arranged on the on-board optical sensor 10 in the vertical direction. However, the on-board sensor cleaning devices 20, 60, and 80 may be arranged next to each other or adjacent to each other in the sideward direction.

In the above embodiments, air is employed as a fluid. However, there is not limitation to such a configuration. A liquid or a gas other than air may be employed.

In the first embodiment, the passage P2, which is configured to draw in fluid (air), is arranged at the pivot center (center axis CL) of the nozzle 24. However, there is not limitation to such a structure. The passage P2 may be separated from the pivot center (center axis CL) of the nozzle 24.

The structure of the second embodiment includes the pulleys 65a to 65e and the wire 66, which runs along the pulleys 65a to 65e, as the slide mechanism 62. However, different structure may be employed as long as sliding along the optical surface 11 is allowed.

In the above embodiments, the on-board optical sensor 10 (e.g., LIDAR or camera), which is an optical sensor, is employed as an on-board sensor. However, there is no limitation to such a structure. An on-board sensor other than the on-board optical sensor 10 (for example, radar using radio wave (e.g., millimeter wave radar) or ultrasonic sensor used as corner sensor) may be employed.

Although not particularly described in the third embodiment, for example, a passage switching unit (passage switching means), which is described below, may be employed to switch the ejection ports. In the following example, the number of the ejection ports is four, and a passage switching unit functions as part of the pump 22. The passage switching unit described below is an example, and there is no limitation to such a structure.

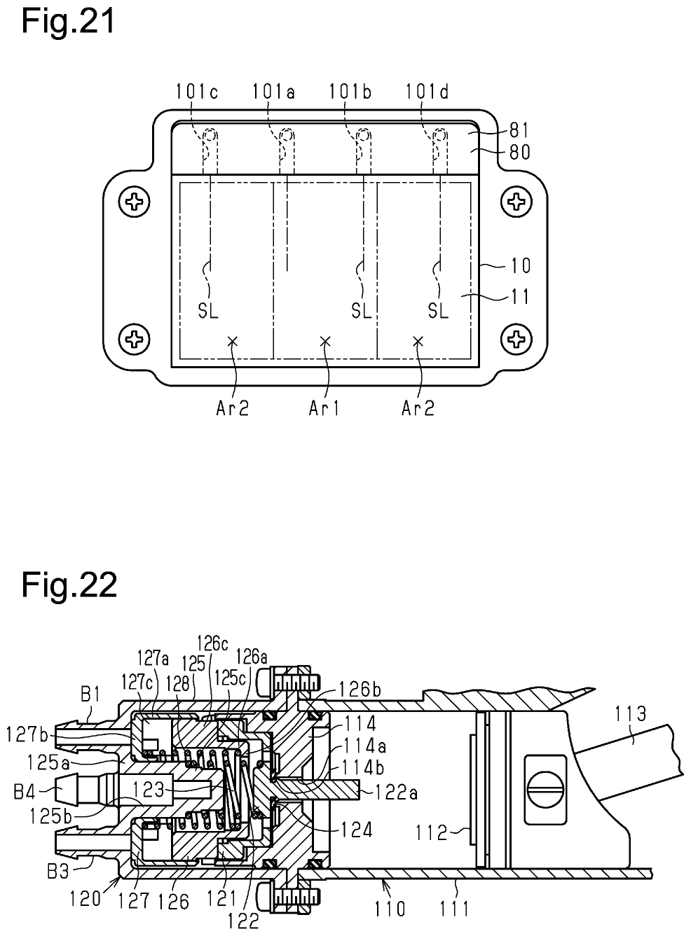

As shown in FIG. 21, the on-board sensor cleaning device 80 in the present example includes the fixed nozzle 81 including four ejection ports 101a to 101d. In the present example, in the same manner as the third embodiment, the important region Ar1 having a relatively high ejection priority is set in advance at a central portion of the optical surface 11 in the sideward direction, and the regular region Ar2 having a relatively low ejection priority is set in advance at each of the two sideward ends of the optical surface 11. The ejection axes SL of the ejection ports 101c and 101d are respectively set in the regular regions Ar2. The ejection axes SL of the two ejection ports 101a and 101b are set in the important region Ar1.

As shown in FIG. 22, the pump 22 includes a drive source (not shown), a pump main body 110, and a passage switching unit 120.

The pump main body 110 includes a cylinder 111 and a piston 112. The piston 112 is accommodated in the cylinder 111 and moved back and forth by the driving force of the drive source (not shown). The piston 112 is connected to a transmission rod 113 that is directly or indirectly connected to the drive source. The transmission rod 113 transmits the driving force of the drive source and moves the piston 112 back and forth in an axial direction of the cylinder 111.

The cylinder 111 has an open end to which a cylinder end 114 is fixed. The cylinder end 114 includes a through hole 114a in a central portion, and a discharge port 114b is arranged in an end of the through hole 114a at the outer end side of the cylinder 111. A compression coil spring 123, which will be described later, biases a valve portion 122 toward the discharge port 114b. The valve portion 122 is formed integrally with a direct-acting member 121, which will be described later. The valve portion 122 includes a shaft 122a extending from the valve portion 122 through the through hole 114a (so that distal end projects into cylinder 111). A seal rubber 124 is fitted and attached on the shaft 122a at a side of the valve portion 122 opposing the discharge port 114b.

Thus, when the piston 112 is moved forth, the piston 112 biases the shaft 122a to open the valve portion 122 against the biasing force of the compression coil spring 123. This discharges the compressed air from the discharge port 114b of the pump main body 110.

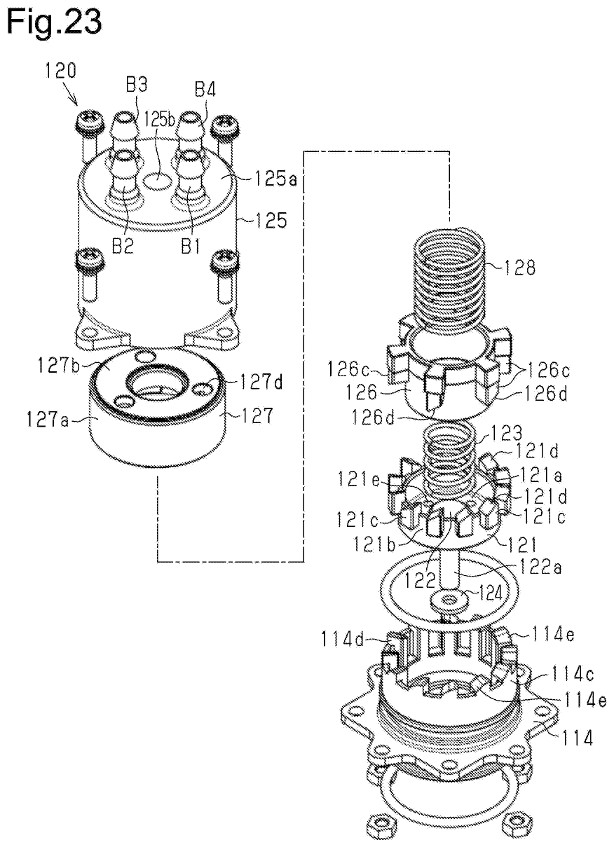

As shown in FIGS. 22 and 23, the passage switching unit 120 includes a case 125, the direct-acting member 121, a direct-acting rotation member 126, a rotation switching member 127, the compression coil spring 123, and a compression coil spring 128a. The case 125 is substantially cylindrical and includes a closed bottom. The compression coil springs 123 and 128a have different diameters. The case 125 accommodates the direct-acting member 121, the direct-acting rotation member 126, and the rotation switching member 127.

Further, in the present embodiment, part of the cylinder end 114 forms part of the passage switching unit 120.

Specifically, as shown in FIG. 23, the cylinder end 114 includes a cylindrical portion 114c that is fitted into a proximal end of the case 125. The cylindrical portion 114c includes a plurality of fixed projections 114d at the distal end projecting inward in a radial direction and extending in the axial direction. The fixed projections are formed in a circumferential direction. The present embodiment includes twelve fixed projections 114d formed in substantially equal angular intervals (approximately 30°) in the circumferential direction. Each fixed projection 114d includes a distal end surface where an inclination surface 114e is formed and inclined in the circumferential direction (specifically, of which axial height decreases clockwise in radial direction as viewed from distal end side).

Further, the case 125 includes a bottom 125a at the end opposite to the cylinder end 114. The bottom 125a includes first to fourth outlets B1 to B4 in substantially equal angular intervals (approximately 90°). Moreover, as shown in FIG. 22, the bottom 125a includes a large diameter cylindrical portion 125b at a central portion extending toward the cylinder end 114. The large diameter cylindrical portion 125b includes a small diameter cylindrical portion 125c, of which diameter is small, at the distal end extending toward the cylinder end 114. The small diameter cylindrical portion 125c is cylindrical and includes a closed bottom.

As shown in FIG. 23, the direct-acting member 121 includes a disk portion 121a, a cylindrical portion 121b, and a plurality of direct-acting projections 121c. The disk portion 121a extends from the edge of the valve portion 122 outward in the radial direction. The cylindrical portion 121b extends from the edge of the disk portion 121a in the axial direction. The direct-acting projections 121c arranged in the circumferential direction project from the distal end of the cylindrical portion 121b in the axial direction and outward in the radial direction. In the present embodiment, twelve direct-acting projections 121c are formed in the circumferential direction in substantially equal angular intervals (approximately 30°). The direct-acting projections 121c are located between the fixed projections 114d and arranged relative to the fixed projection 114d in a manner immovable in the circumferential direction and movable in the axial direction. This allows only linear movement of the direct-acting member 121. Each direct-acting projection 121c includes a distal end surface where an inclination surface 121d is arranged and inclined in the circumferential direction (specifically, having axial height decreased in clockwise direction as viewed from distal end side). Further, the disk portion 121a includes a plurality of ventilation holes 121e to allow for passage of air. Moreover, as shown in FIG. 22, the direct-acting member 121 is biased by the compression coil spring 123 together with the valve portion 122 toward the cylinder end 114 (toward discharge port 114b). The compression coil spring 123 has one end fitted onto the small diameter cylindrical portion 125c and supported by a step formed by the large diameter cylindrical portion 125b.

The direct-acting rotation member 126 includes a cylindrical portion 126a, an inward extension portion 126b, and a plurality of direct-acting rotation projections 126c. The cylindrical portion 126a has a smaller diameter than the cylindrical portion 121b of the direct-acting member 121. The inward extension portion 126b extends from the proximal end of the cylindrical portion 126a (side of discharge port 114b) inward in the radial direction (refer to FIG. 22). The direct-acting rotation projections 126c project from the distal end of the cylindrical portion 126a outward in the radial direction. In the present embodiment, six direct-acting rotation projections 126c are formed in substantially equal angular intervals (approximately) 60° in the circumferential direction. Each direct-acting rotation projection 126c includes a proximal end surface where an inclination surface 126d is arranged and inclined in the circumferential direction (specifically, along inclination surface 114e of fixed projection 114d and inclination surface 121d of direct-acting projection 121c).

The direct-acting rotation member 126 is arranged so that the proximal end of the cylindrical portion 126a is accommodated in the cylindrical portion 121b of the direct-acting member 121 and that the direct-acting rotation projections 126c are configured to contact the inclination surfaces 114e of the fixed projections 114d and the inclination surfaces 121d of the direct-acting projections 121c in the axial direction. Further, the direct-acting rotation projections 126c are configured to be located between the fixed projections 114d in the circumferential direction in a state in which the direct-acting rotation member 126 is positioned at the side of the discharge port 114b. In this state, only linear movement of the direct-acting rotation member 126 is allowed. In a state in which the direct-acting rotation member 126 is positioned at the side opposite to the discharge port 114b, rotational movement of the direct-acting rotation member 126 is also allowed.

The rotation switching member 127 includes an accommodation cylindrical portion 127a and a disk portion 127b. The accommodation cylindrical portion 127a is configured to accommodate the distal end of the direct-acting rotation member 126. The disk portion 127b extends from the distal end of the accommodation cylindrical portion 127a inward in the radial direction and opposes the bottom 125a of the case 125 in the axial direction. Further, the accommodation cylindrical portion 127a includes an inner surface where a plurality of projections 127c are formed to engage with the direct-acting rotation projections 126c in the circumferential direction (refer to FIG. 22). The rotation switching member 127 is arranged in a manner integrally rotatable with the direct-acting rotation member 126 (relatively non-rotatable) and movable relative to the direct-acting rotation member 126 in a linear movement direction. The compression coil spring 128 is sandwiched in a compressed state between the disk portion 127b of the rotation switching member 127 and the inward extension portion 126b of the direct-acting rotation member 126 in the axial direction. In this manner, the bottom 125a of the case 125 contacts and presses the rotation switching member 127 (disk portion 127b) so that the direct-acting rotation member 126 is biased toward the discharge port 114b. Furthermore, the disk portion 127b includes connection holes 127d that close (connect) at least one of the first to fourth outlets B1 to B4 in accordance with a rotation position of the rotation switching member 127. This allows for switching of the outlets B1 to B4, which is connected to the discharge port 114b.

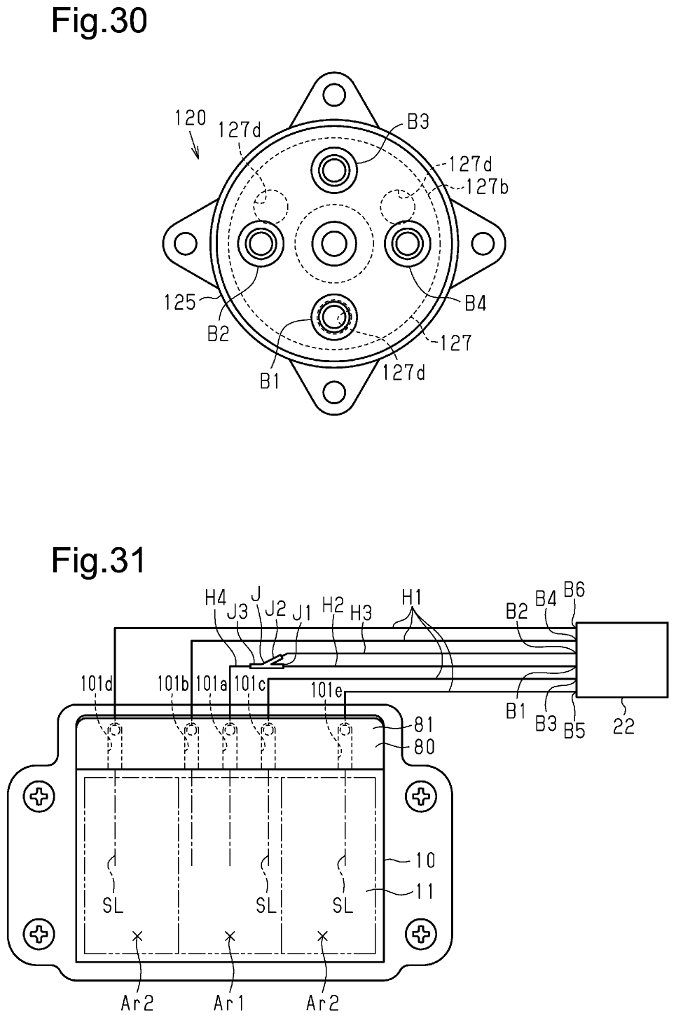

Specifically, as shown in FIGS. 23 and 30, the connection holes 127d of the present embodiment are configured so that three connection holes 127d are formed in substantially equal angular intervals (approximately 20°), and a different one of the outlets B1 to B4 is sequentially connected with the discharge port 114b by the connection hole 127d whenever the rotation switching member 127 is rotated by approximately 30°. That is, in the state shown in FIG. 30, one connection hole 127d is located at a position that coincides with the first outlet B1. In this state, the second to fourth outlets B2 to B4 are closed by the disk portion 127b and not connected to the discharge port 114b. Then, for example, when the rotation switching member 127 is rotated by approximately 30° in a counterclockwise direction, the connection hole 127d (in FIG. 30, left upper one) will be located at a position that coincides with the second outlet B2 so that the second outlet B2 will be connected with the discharge port 114b by the connection hole 127d. When the rotation switching member 127 is further rotated by approximately 30° from this state in the counterclockwise direction, the connection hole 127d (in FIG. 30, right upper one) will be located at a position that coincides with the third outlet B3 so that the third outlet B3 will be connected with the discharge port 114b by the connection hole 127d. When the rotation switching member 127 is further rotated by 30° from this state in the counterclockwise direction, the connection hole 127d (in FIG. 30, lower one) will be located at a position that coincides with the fourth outlet B4 so that the fourth outlet B4 will be connected with the discharge port 114b by the connection hole 127d. When the rotation switching member 127 is further rotated by 30° from this state in the counterclockwise direction, the connection hole 127d (in FIG. 30, left upper one) will be located at a position that coincides with the first outlet B1 so that the first outlet B1 will be connected with the discharge port 114b by the connection hole 127d. By such a repetition, the outlets B1 to B4 are sequentially connected with the discharge port 114b by the connection hole 127d. Here, the inclination direction of the inclination surfaces 114e, 121d, and 126d in the present embodiment are illustrated in an opposite direction, and therefore, a rotation direction of the rotation switching member 127 does not correspond to a rotation direction of the rotation switching member 127 as discussed above.

An example of the operation of the above structure will now be described.

First, when the piston 112 is at a bottom dead center (farthest location from cylinder end 114), the direct-acting member 121 is located at the side of the cylinder end 114 and the discharge port 114b is closed by the valve portion 122.

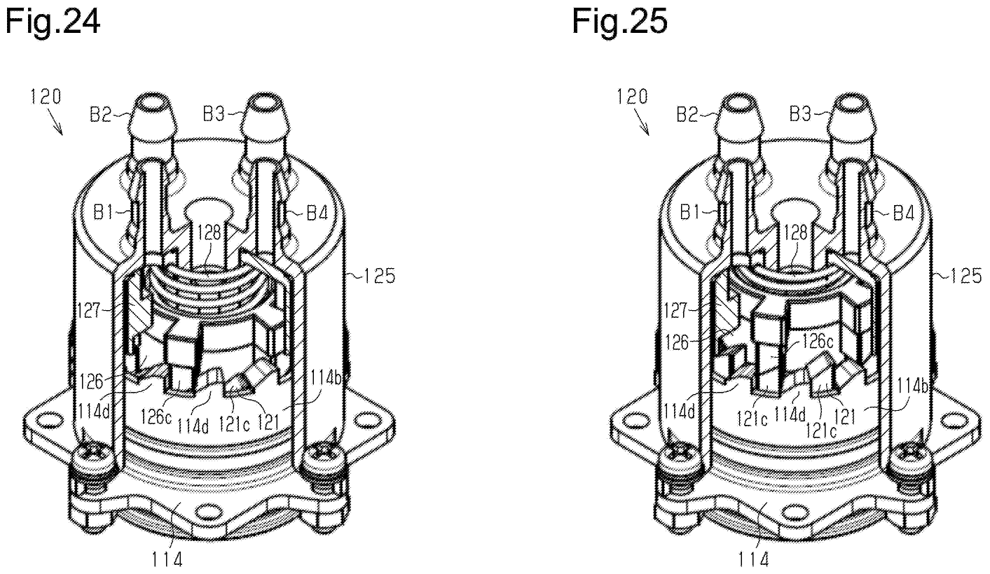

Further, in this state as shown in FIG. 24, the direct-acting projections 121c of the direct-acting member 121 are arranged between the fixed projections 114d, and the direct-acting rotation projections 126c of the direct-acting rotation member 126 are located between the fixed projections 114d. In this state, movement (rotation) of the direct-acting rotation member 126 and the rotation switching member 127 in the circumferential direction is restricted.

Next, when the piston 112 is moved forth, the air inside the cylinder 111 is compressed until the piston 112 contacts the shaft 122a of the direct-acting member 121.

Then, when the piston 112 is further moved forth, the piston 112 biases the shaft 122a so that the direct-acting member 121 including the valve portion 122 is linearly moved slightly toward the distal end (side of bottom 125a of case 125) against the biasing force of the compression coil spring 123. This opens the valve portion 122 and discharges the compressed air from the discharge port 114b. In this case, the air is ejected from, for example, the first outlet B1 that is located at the position coinciding with the connection hole 127d and connected with the discharge port 114b. Then, the air passes through a hose (not shown) and ejected from the first ejection port 101a (refer to FIG. 1) onto the optical surface 11. In this case, the direct-acting projections 121c bias the direct-acting rotation projections 126c so that the direct-acting rotation member 126 is also slightly moved toward the distal end (side of bottom 125a of case 125) against the biasing force of the compression coil spring 128.

Subsequently, when forward movement of the piston 112 further moves the direct-acting member 121 (direct-acting projections 121c) linearly toward the distal end, as shown in FIG. 25, the direct-acting rotation member 126 is also moved linearly toward the distal end (side of bottom 125a of case 125) until reaching a predetermined position where the direct-acting rotation projections 126c no longer contact the fixed projections 114d in the circumferential direction.

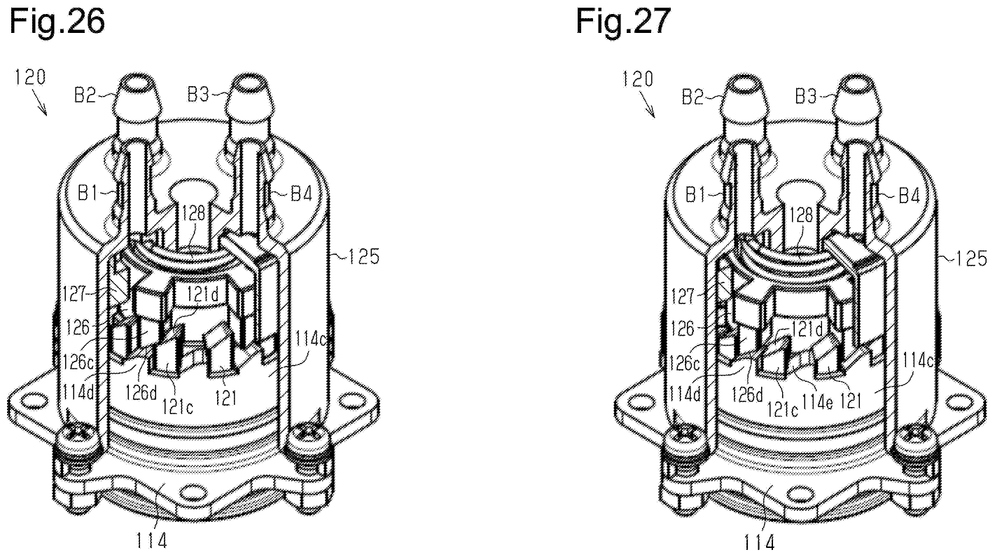

When the forward movement of the piston 112 further moves the direct-acting member 121 (direct-acting projection 121c) linearly, as shown in FIG. 26, the direct-acting rotation projections 126c do not contact the fixed projections 114d in the circumferential direction beyond the predetermined position. In this case, the inclination surfaces 121d and 126d convert the linear movement into rotational movement and rotates the direct-acting rotation member 126 and the rotation switching member 127.

Accordingly, as shown in FIG. 27, the direct-acting rotation projections 126c of the direct-acting rotation member 126 are in a state positioned next to the fixed projections 114d in the axial direction (in a state in which the positions of direct-acting rotation projections 126c and fixed projections 114d coincide in circumferential direction).

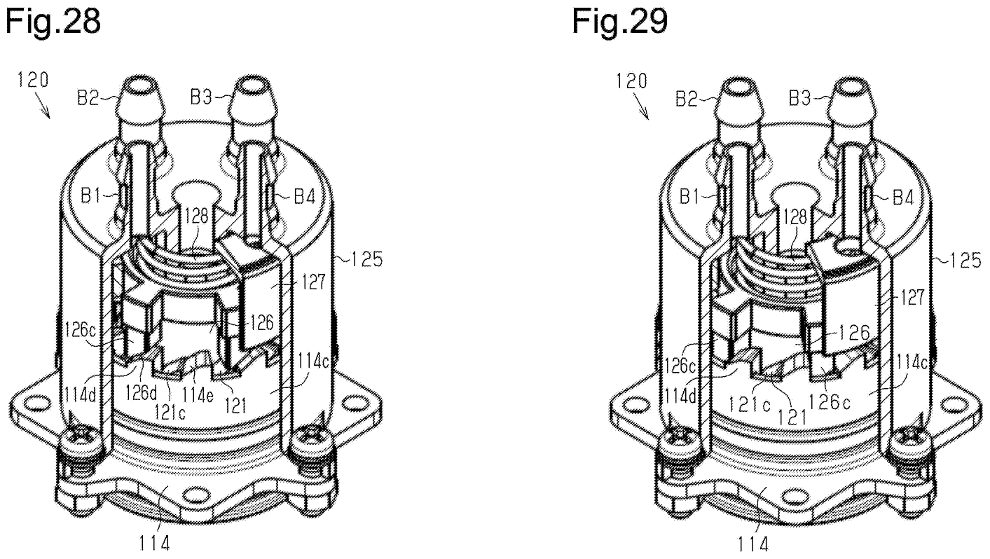

Then, as shown in FIG. 28, when the piston 112 is moved back and the direct-acting projections 121c of the direct-acting member 121 are arranged between the fixed projections 114d, the inclination surfaces 114e and 126d convert the linear movement of the compression coil spring 128 into rotational movement and further rotates the direct-acting rotation member 126 and the rotation switching member 127.

Subsequently, as shown in FIG. 29, the direct-acting rotation projections 126c of the direct-acting rotation member 126 are located between the fixed projections 114d that are next to the ones between which the direct-acting rotation projections 126c were located in the first state (refer to FIG. 24). Thus, movement (rotation) of the direct-acting rotation member 126 and the rotation switching member 127 in the circumferential direction is restricted. In this case, for example, the connection hole 127d is located at the position coinciding with the second outlet B2. Therefore, when the valve portion 122 opens next, air will be ejected from the second outlet B2, which is connected with the discharge port 114b.

By repeating the above-described operation, air is sequentially ejected from the ejection ports 101a to 101d.

In the above modified example, the number of outlets B1 to B4 and the ejection ports 101a to 101d are the same. However, there is no limitation to such a structure. For example, the number of the outlets may be greater than that of the ejection ports.

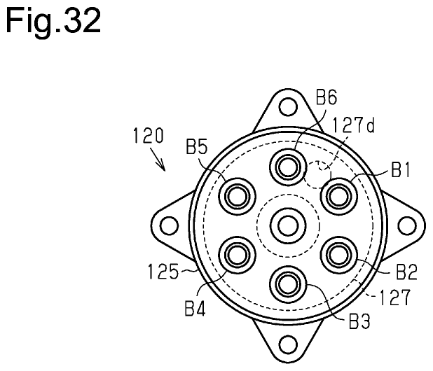

As shown in FIGS. 31 and 32, the pump 22 includes first to sixth outlets B1 to B6 formed in equal angular intervals (approximately 60°) and one connection hole 127d formed in the rotation switching member 127. Thus, different one of the outlets B1 to B6 will sequentially be connected with the connection hole 127d whenever the rotation switching member 127 is rotated by 60°. Specifically, the connection hole 127d is connected with the outlets B1 to B6 in the order of the first outlet B1, second outlet B2, third outlet B3, fourth outlet B4, fifth outlet B5, and sixth outlet B6.

As shown in FIG. 31, the fixed nozzle 81 includes five ejection ports 101a, 101b, 101c, 101d, and 101e.

The four outlets B3 to B6 of the outlets B1 to B6 are respectively connected to (in communication with) the ejection ports 101b to 101e by a separate hose H1.

The outlets B1 and B2 of the outlets B1 to B6 are connected to the ejection port 101a. Specifically, the outlet B1 is connected to one end of hose H2, and the outlet B2 is connected to one end of hose H3 differing from the hose H2. Further, the other ends of the hoses H2 and H3, which are connected to the outlets B1 and B2, are respectively connected to a first connecting port J1 and a second connecting port J2 of a joint member J. The joint member J is a Y-shaped joint member including the first connecting port J1, the second connecting port J2, and a third connecting port J3. The third connecting port J3 of the joint member J is connected to one end of hose H3. The other end of the hose H3 is connected to the ejection port 101a.

In the above employed structure, when the pump 22 is driven, air is ejected twice from the ejection port 101a and then the air is separately ejected from the other ejection ports 101b to 101e one at a time. Specifically, the ejection frequency of the air ejected from the ejection port 101a, which is located at the central portion of the optical surface 11 in the sideward direction and of which the ejection axis SL is set in the important region Ar1, can be increased more than, for example, the ejection frequency of the air ejected from the other ejection ports 101d and 101e, of which the ejection axes SL are set in the regular region Ar2. This allows for cleaning with emphasis on the central portion (important region Ar1) where the priority is high in the optical surface 11.

The above embodiments and the modifications may be combined in any suitable manner.

1. An on-board sensor cleaning device, comprising:
a nozzle including one or more ejection ports that eject a fluid onto a sensing surface of an on-board sensor;
wherein an ejection duration or an ejection frequency of the fluid, which is ejected onto the sensing surface, differs in accordance with a position on the sensing surface.

2. The on-board sensor cleaning device according to claim 1, wherein
the sensing surface includes an important region, which is where an ejection priority is high, and a regular region, where the priority is lower than the important region, and
the ejection duration of fluid per unit area is longer or the ejection frequency is higher in the important region than the regular region.

3. The on-board sensor cleaning device according to claim 2, wherein the important region is set at a central portion of the sensing surface.

4. The on-board sensor cleaning device according to claim 2, wherein the important region is a region that includes a transmission range through which light emitted from a light emitter of the on-board sensor is transmitted.

5. The on-board sensor cleaning device according to claim 1, wherein the nozzle is a movable nozzle that moves the ejection port to change a position of an ejection axis of the ejection port.

6. The on-board sensor cleaning device according to claim 2, wherein
the nozzle is a movable nozzle that moves the ejection port to change a position of an ejection axis of the ejection port,
the movable nozzle is at least one of movable nozzles, and
the ejection axis of each of the movable nozzles is configured to be set in the important region.

7. The on-board sensor cleaning device according to claim 2, wherein
the nozzle is a fixed nozzle that includes ejection ports located along the sensing surface, and
fluid ejected from the ejection port of which an ejection axis is set in the important region has a longer ejection duration per unit area or a higher ejection frequency than fluid ejected from the ejection port of which the ejection axis is set in the regular region.

8. The on-board sensor cleaning device according to claim 2, wherein
the nozzle is a fixed nozzle that includes ejection ports located along the sensing surface, and
the fluid is sequentially ejected from the ejection ports, and
a number of the ejection ports of which ejection axes are set in the important region is greater than a number of the ejection ports of which the ejection axes are set in the regular region.

9. The on-board sensor cleaning device according to claim 2, wherein
the nozzle is a fixed nozzle that includes ejection ports located along the sensing surface, and
the fluid is sequentially ejected from the ejection ports, and
an arrangement interval of the ejection ports of which ejection axes are set in the important region is narrower than an arrangement interval in which the ejection ports of which the ejection axes are set in the regular region.

10. The on-board sensor cleaning device according to claim 1, wherein the fluid is a gas.
